(19) United States
(12) Patent Application Publication
(10) Pub. No.: US 2011/0163540 A1
(43) Pub. Date: Jul. 7, 2011

(54) O-RINGLESS SEAL COUPLINGS

(75) Inventors: Timothy W. Towle, Lee, NH (US); Douglas J. Norris, North Chelmsford, MA (US)

(73) Assignee: ENTEGRIS, INC., Bellerica, MA (US)

(21) Appl. No.: 12/741,146

(22) PCT Filed: Nov. 3, 2008
(86) PCT No.: PCT/US08/82289

§ 371 Date: Mar. 10, 2011

(30) Foreign Application Priority Data
Nov. 2, 2007 (US) 60985103

(51) Int. Cl. F16L 17/00

(52) U.S. Cl. 285/352

(57) ABSTRACT

An operative fluid device (14) comprising a fluoropolymer body portion (24) and a fluoropolymer containment portion (22) connectable to one another for containing the fluid at a fluid sealing connection with two frustoconical surfaces (42, 74) that first confront one another and then engage one another as the connection is made, one of the frustoconical surfaces being convex and the other concave, wherein when the surfaces are confronting one another before they are engaged they are angularly mismatched, and wherein the frustoconical surfaces first sealing contact is at a radially inward annular position on each of the frustoconical surfaces and proximate the interior, and as the mating portions are urged together, the sealing contact expands from the radially inward annular position radially outward to include majority of at least one of the two angularly mismatched frustoconical surfaces. Suitable annular structure including annular rings (70) and annular recesses radially outboard from the frustoconical surfaces may provide radial constraint to the frustoconical surfaces as they are engaged and such annular structure may provide additional annular supplemental seals.

### RELATED APPLICATIONS

This application claims the benefit of U.S. Provisional Application No. 60/985,103, entitled O-RINGLESS FITTINGS, filed Nov. 2, 2007, said application being hereby fully incorporated herein by reference.

### FIELD OF THE INVENTION

The present disclosure generally relates to fluid seals. More particularly, embodiments of the present disclosure relate to O-ringless fluid seal couplings for operative fluid devices, such as liquid filtration devices, valves, and sensors for use in critical fluids management.

### BACKGROUND

Numerous industries and many applications utilize metallic tubes, fittings, and various other “plumbing” components for handling and controlling critical fluid flow. Such components may be made of metals such as copper, stainless steel, or steel. Conventional fluid seals include elastomeric O-rings or gaskets. Although such seals can be relatively inexpensive, and can be effective at sealing in most cases, such seals are not effective for all environments. In particular applications, such as semiconductor processing, the fluids involved react with and/or may be contaminated by the use of metallic components, conventional gaskets or elastomeric O-rings. Thus, in such industries, plumbing components are made of highly inert materials such as fluoropolymers.

As an example, in harsh chemical environments, which are present in the liquid filtration of microelectronics process-fluids, O-rings made of chemically resistant materials (e.g., KALREZ®) often must be used. However, these O-rings can be expensive and often need frequent replacements.

Furthermore, in applications where the process-fluid can be prone to crystallization, small volumes of dead space around a radial or face-seal O-ring can cause the process-fluid to crystallize, thus leading to leaks at the seal or other undesirable effects to the process-fluid. In addition, burrs and other surface defects on O-ring sealing surfaces can provide additional leak points between devices.

In harsh chemical environments, gaskets made of chemically resistant materials (e.g., KALREZ®) may be used. However, these designs can require a very large closure force and can be expensive.

There is therefore a need for an improved O-ringless fluid seal for use in harsh chemical environment fluid systems, such as for use with liquid filtration devices for microelectronics process-fluids that addresses the above deficiencies.

### SUMMARY OF THE INVENTION

An O-ringless fluid seal suitable for use in harsh chemical environments and suitable for operative fluid devices includes the operative fluid devices and methods for accomplishing the seal.

In an embodiment, an operative fluid device comprising a fluoropolymer body portion and a fluoropolymer containment portion connectable to one another for containing the fluid at a fluid sealing connection with two frustoconical surfaces that first confront one another and then engage one another as the connection is made, one of the frustoconical surfaces being convex and the other concave, wherein when the surfaces are confronting one another before they are engaged they are angularly mismatched, and wherein the frustoconical surfaces first sealing contact is at a radially inward annular position on each of the frustoconical surfaces and proximate the interior, and as the mating portions are urged together, the sealing contact expands from the radially inward annular position radially outward to include majority of at least one of the two angularly mismatched frustoconical surfaces. Suitable annular structure including annular rings and annular recesses may provide radial constraint to the frustoconical surfaces as they are engaged and such annular structure may provide additional annular supplemental seals.

In embodiments, a polymer containment portion connected to a body portion via the fluid tight seal defines an interior which contains one of a fluid control portion, a fluid filter portion, and a fluid measurement portion. The body portion and the polymer containment portion define cylindrical interior wall portions at the fluid tight seal and have a common axis.

In particular embodiment, as the first and second mating portions are coupled in order to form an O-ringless fluid seal, at least one, two or three of three sealing surfaces can be deformed, deflected or otherwise distorted from its un-sealed configuration with respect to each mating portion.

In certain embodiments, the O-ringless fluid coupling can be used for coupling a liquid filtration device to filtration housing in a microelectronics process-fluid system. In one embodiment, a single O-ringless fluid seal is created in a coupling. In another embodiment, two O-ringless fluid seals are created in a coupling. In yet another embodiment, three O-ringless fluid seals are created.

According to certain embodiments, the O-ringless fluid tight seal, comprising a first mating portion and a second mating portion is disclosed for creating a sealing connection between two components. The first mating portion has a proximal end for receiving the second mating portion. The first mating portion also has a distal end which is operably attached to one of the components. The first mating portion also has a first rim portion, a second rim portion, and an annular groove portion interposed between the first rim portion and the second rim portion. The first rim portion has a first sealing surface and a second sealing surface. The second rim portion has a third sealing surface. A first angle is defined by the first sealing surface and the cylindrical interior wall portion taken in an cross-section parallel to the axis, and a second angle is defined by the third sealing surface and the annular groove taken in a cross-section parallel to the axis.

The second mating portion has a proximal end for receiving the first mating portion. The second mating portion has a distal end which is operably attached to the other component. The second mating portion also has a third rim portion, a first mating sealing surface, and a third mating sealing surface. The third rim portion has a second mating sealing surface. A third angle is defined by the first mating sealing surface and the cylindrical interior wall portion, and a fourth angle is defined by the third sealing surface and the cylindrical interior wall portion.

First and second mating portions are configured such that the first angle is not equal to the third angle, and the second angle is not equal to the fourth angle.

The two mating portions are configured so that they can be assembled together. When the parts are assembled, without any axially compressive force acting on them, the annular ring is configured to receive the third rim portion, the first sealing surface confronts the first mating sealing surface, the second sealing surface is radially adjacent to the second mating sealing surface, and the third sealing surface confronts the third mating sealing surface.

When a force acts to axially compress the first mating portion to the second mating portion, the force is transferred through both the first and second mating portions such that the first sealing surface is compressed against the first mating sealing surface. This compressive force results in a deflection to at least one of first sealing surface and first mating sealing surface.

According to certain embodiments of this invention, when a force acts to axially compress the first mating portion to the second mating portion, at least one of first sealing surface and first mating sealing surface is deformed.

According to certain embodiments of this invention, when a force acts to axially compress the first mating portion to the second mating portion, the force is transferred through both the first and second mating portions such that the second sealing surface is compressed against the second mating sealing surface. This compression results in a deflection to at least one of second sealing surface and second mating sealing surface. According to other embodiments of this invention, the compression also results in a deflection to at least one of third sealing surface and third mating sealing surface.

According to certain embodiments of this invention, the first angle is about forty-five degrees (within two degrees), the second angle is about fifty degrees (within two degrees), the third angle is about forty degrees (within two degrees) and the fourth angle is about forty-five degrees (within two degrees).

According to certain embodiments of this invention, the device is part of one component to be coupled is a liquid filtration assembly used for filtration of microelectronics process-fluids and the other component is a filter housing.

According to certain embodiments of this invention, the first mating portion is comprised of a fluoropolymer. According to other embodiments of this invention, the fluoropolymer is selected from the group consisting of perfluoroalkoxy and polytetrafluoroethylene.

According to certain embodiments of this invention, the second mating portion is comprised of a fluoropolymer. According to other embodiments of this invention, the fluoropolymer is selected from the group consisting of perfluoroalkoxy and polytetrafluoroethylene.

A feature and advantage of embodiments of the seal coupling is that only a low engagement force is needed to bring seals together.

Another feature and advantage of embodiments of the seal coupling is that only a low sealing force is needed to create the seal.

Another feature and advantage of embodiments of the invention is that the fluid seal is formed of non-elastomers, non-elastomeric materials, but rather rigid materials suitable for the rigid materials of fluid control device housings.

Another feature and advantage of embodiments of the seal coupling is that the compressive loading of the sealing surfaces that are adjacent the fluid chamber decrease in a radially outward direction providing a optimally secure seal adjacent the fluid chamber.

A further feature and advantage of embodiments of the seal coupling is that integral seals can be formed that can be utilized at high fluid pressures with low clamping force.

Yet another feature and advantage of embodiments of the seal coupling is that true straight-through flow paths with substantially no dead volumes are formed.

A feature and advantage of embodiments of the arrangement of multiple seal couplings is that enhanced manufacturing tolerances are possible.

The above summary of various embodiments of the invention is not intended to describe each illustrated embodiment or every implementation of the invention. Rather, the embodiments are chosen and described so that others skilled in the art may appreciate and understand the principles and practices of the invention. The figures and the detailed description that follow more particularly exemplify these embodiments.

### BRIEF DESCRIPTION OF THE DRAWINGS

The embodiments of the present invention may be more completely understood in consideration of the following detailed description of various embodiments in connection with the accompanying drawings, in which:

FIG. 1 is a cross-sectional elevation view of an apparatus with an O-ringless fluid tight seal for sealingly connecting two components, according to an embodiment of the present invention;

FIG. 1A is a detail cross-sectional elevation view of one mating portion of the O-ringless fluid tight seal depicted in FIG. 1;

FIG. 1B is a detail cross-sectional elevation view of the other mating portion of the O-ringless fluid tight seal depicted in FIG. 1;

FIG. 2 is a perspective view of an apparatus: a liquid filtration assembly coupled to a filter housing, according to an embodiment of the present invention;

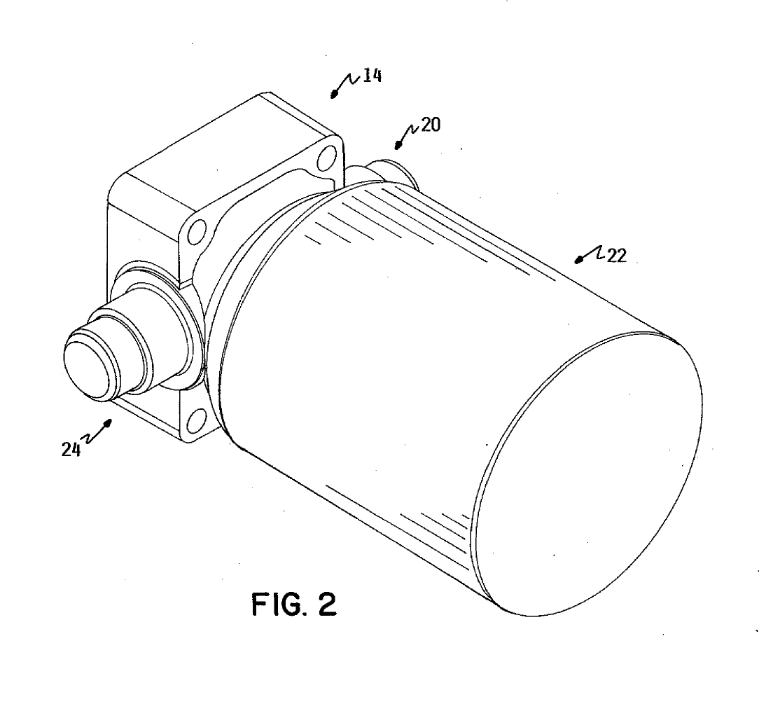

FIG. 3 is a detail cross-sectional elevation view of corresponding mating portions of the O-ringless fluid tight seal depicted in FIG. 1, where no O-ringless fluid tight seal has been formed;

FIG. 4A is a detail cross-sectional elevation view of corresponding mating portions of the O-ringless fluid tight seal depicted in FIG. 1, forming an O-ringless seal;

FIG. 4B is a detail cross-sectional elevation view of corresponding mating portions of the O-ringless fluid tight seal depicted in FIG. 1, forming two O-ringless seals;

FIG. 4C is a detail cross-sectional elevation view of corresponding mating portions of the O-ringless fluid tight seal depicted in FIG. 1, forming three O-ringless seals;

FIG. 5 is a perspective view of a multiple O-ringless fluid tight seal arrangement, according to an embodiment of the present invention, where the O-ringless fluid tight seals are adjacently positioned;

FIG. 6 is a cross-sectional elevation view of a multiple O-ringless fluid tight seal arrangement, according to an embodiment of the present invention, where the O-ringless fluid tight seals are in a concentric configuration; and

FIG. 7 is a cross-sectional plan view of the connecting fluid channels of the multiple O-ringless fluid tight seal arrangement depicted in FIG. 6.

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention.

### DETAILED DESCRIPTION OF THE DRAWINGS

The apparatus according to the present invention can be used in a variety of applications, such as for coupling a liquid filtration device to a filtration housing in a microelectronics process-fluid system.

“Fluid control” includes metering, valving, storing, and switching, “fluid conditioning” includes changing the formulation or purity or specific condition such as temperature or pressure of the fluid; “fluid measurement” includes detecting a condition or characteristic of the fluid. “Integral” when used herein means the two of the components, portions, or elements referenced are unitary and formed of continuous common material.

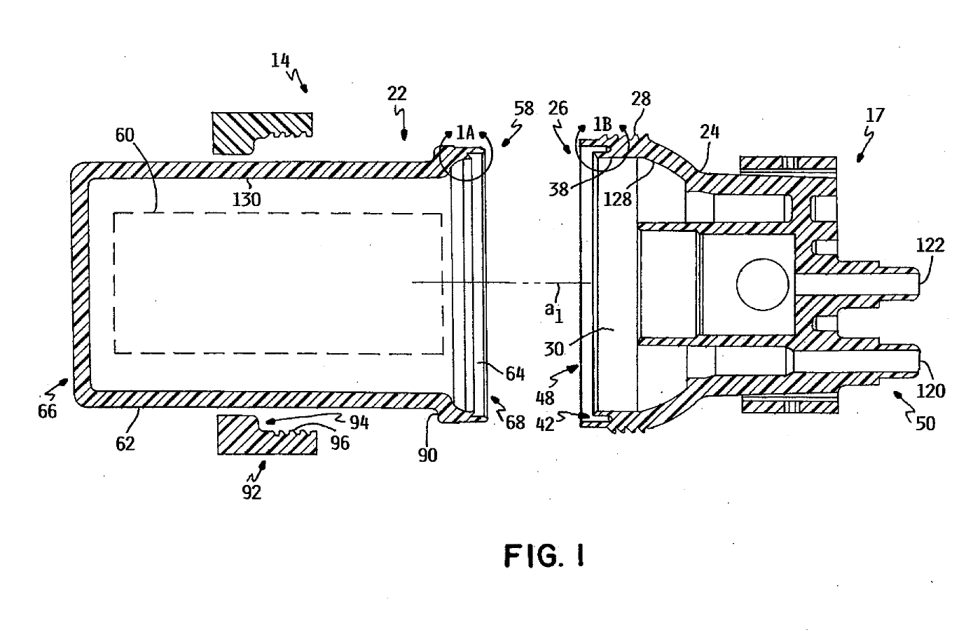

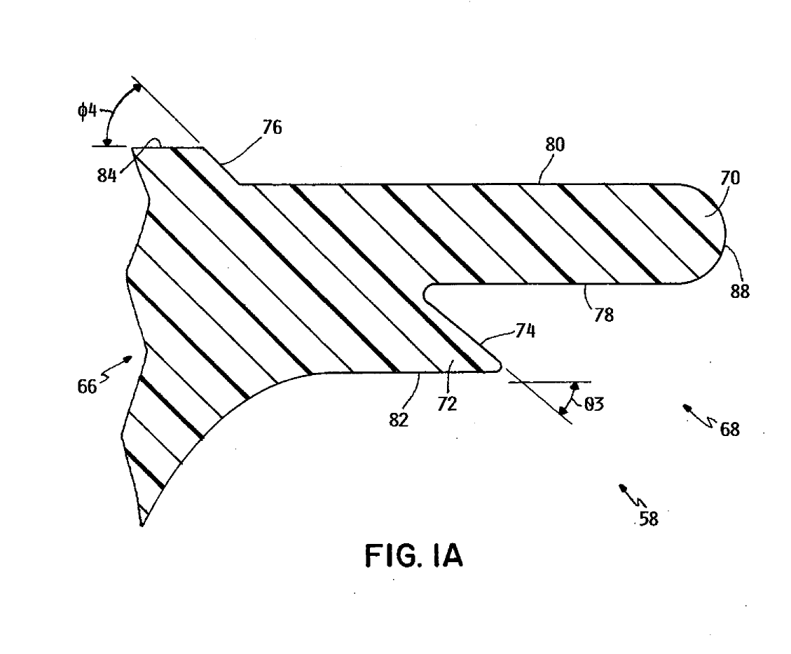

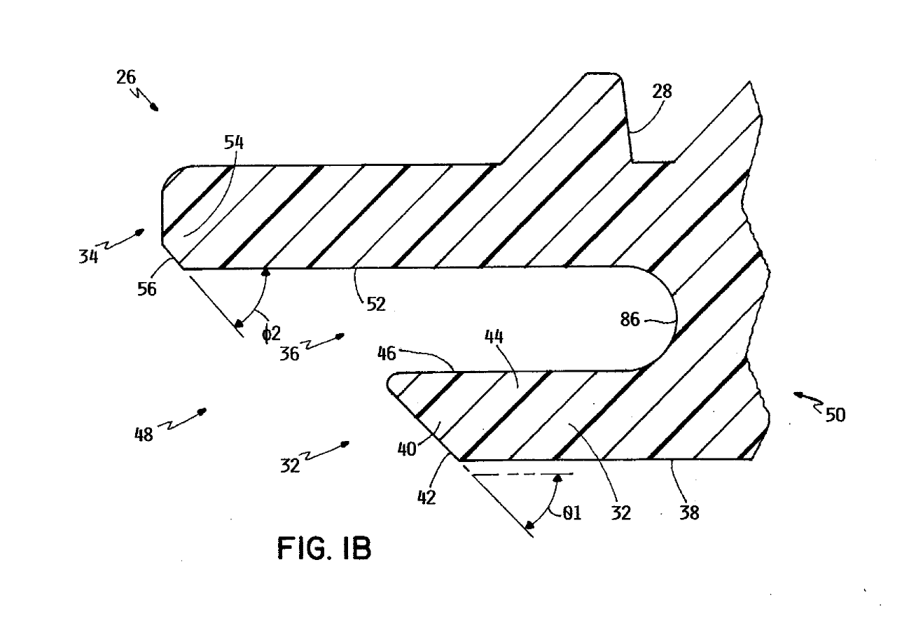

Referring to FIG. 1, an operative fluid device 14 for handling fluid, according to certain embodiments of the present invention, generally includes, a polymer body portion 24 and a polymer containment portion 22 engaging one another at a fluid sealing connection. When polymer body portion 24 and polymer containment portion 22 are engaged, an O-ringless fluid-tight seal is created by fluid sealing connection.

As depicted in FIGS. 1 and 1B, polymer body portion 24 generally includes mating portion 26, external threads 28, an interior 30, a cylindrical interior wall portion 128, a cylindrical wall surface portion 38 at the fluid-tight seal, an axis a1, a pair of fluid flow conduits 120, 122 and has a proximal end 48 and a distal end 50, according to certain embodiments of the present invention. Both cylindrical interior wall portion 128 and cylindrical wall surface portion 38 are substantially circular with respect to axis 126.

Mating portion 26, which is integral with polymer body portion 24, generally includes first annular ring 32, second annular ring 34, and gap or annular groove 36. First annular ring 32 has concave frustoconical sealing surface 42 positioned on tip 40, and adjoining cylindrical wall surface portion 38. Acute angle θ1 is formed by concave first frustoconical sealing surface 42 and axis a1.

When viewed in a cross-section, as depicted in FIG. 1B, first annular ring 32, second annular ring 34, and gap 36 are each substantially parallel to axis a1. Second annular ring 34 extends axially away from body portion 24 and is spaced from first angular ring 32 by gap 36. Second annular ring 34 has tip 54 and protrudes farther axially away from the body portion than tip 40 of first annular ring 32. At the distal end 50 of gap 36 is radiused surface 86.

Second annular ring 34 has a third sealing surface 56. Acute angle φ2 is formed by third sealing surface 56 and common axis a1 which is also parallel to inwardly facing surface 52.

Referring to FIGS. 1 and 1A, polymer containment portion 22 generally includes mating portion 58, operative portion 60 here shown as a filter, housing 62, interior 64, shoulder 90, cylindrical interior wall portion 130, cylindrical wall surface portion 82 at the fluid-tight seal, and axis a1 according to certain embodiments of the present invention. Polymer containment portion 22 has a distal end 66 and a proximal end 68. Both cylindrical interior wall portion 130 and cylindrical wall surface portion 82 are substantially circular with respect to axis a1.

Mating portion 58, which is integral with polymer containment portion 22, generally includes third annular ring 70, and concave frustoconical sealing surface 74. Acute angle θ3 is formed by convex second frustoconical sealing surface 74 and common axis a1 which is also parallel to cylindrical wall surface portion 82 which is adjacent to convex frustoconical sealing surface 74. Acute angle φ4 is formed by third sealing surface 76 and common axis a1 which is also parallel to outwardly facing surface 84.

When viewed in a cross-section, as depicted in FIG. 1A, in inward and outward surfaces of the third annular ring 70 is substantially parallel to axis a1.

Second annular ring 34 extends axially away from body portion 24 and is spaced from first angular ring 32 by gap 36. Second annular ring 34 has tip 54 and protrudes farther axially away from the body portion than tip 40 of first annular ring 32 providing protection to the frustoconical sealing surface.

At the distal end 50 of third annular ring 70 is radiused surface 88.

According to certain embodiments of the invention, angle θ1 does not equal angle θ3. In one embodiment, angle θ1 can be approximately 45 degrees and angle θ3 can be approximately 40 degrees. In another embodiment, angle θ3 can be approximately within the range of 30 degrees and 60 degrees, and angle θ1 can be equal to angle θ3+approximately 3 to 15 degrees.

According to certain embodiments of the invention, angle φ2 does not equal angle φ4. In one embodiment, angle φ2 can be approximately 50 degrees and angle φ4 can be approximately 45 degrees. In another embodiment, angle φ4 can be approximately within the range of 30 degrees and 60 degrees, and angle φ2 can be equal to angle φ4+approximately 4 to 8 degrees, preferably about 5 degrees.

According to certain embodiments of the invention, mating portion 58 of containment assembly 22 can be fabricated from a fluoropolymer such as PFA Perfluoroalkoxy or PTFE Polytetrafluoroethylene. According to certain embodiments of the invention, mating portion 26 of filter housing 24 can be fabricated from a fluoropolymer such as PFA Perfluoroalkoxy or PTFE Polytetrafluoroethylene. According to certain embodiments of the invention, mating portion 58 of containment portion 22 and mating portion 26 of body portion 24 can be fabricated from different materials. According to certain embodiments of the invention, mating portion 58 of containment portion 22 and mating portion 26 of body portion 24 can both be fabricated from the same material. Notably the material sufficiently rigid for the housing such as PFA is used for the actual sealing surfaces.

Nut 92 has shoulder 94 and internal threads 96. Shoulder 94 is shaped to work cooperatively with shoulder 90 of the containment portion 22. Internal threads 96 are correspondingly threaded to engage with external threads 28.

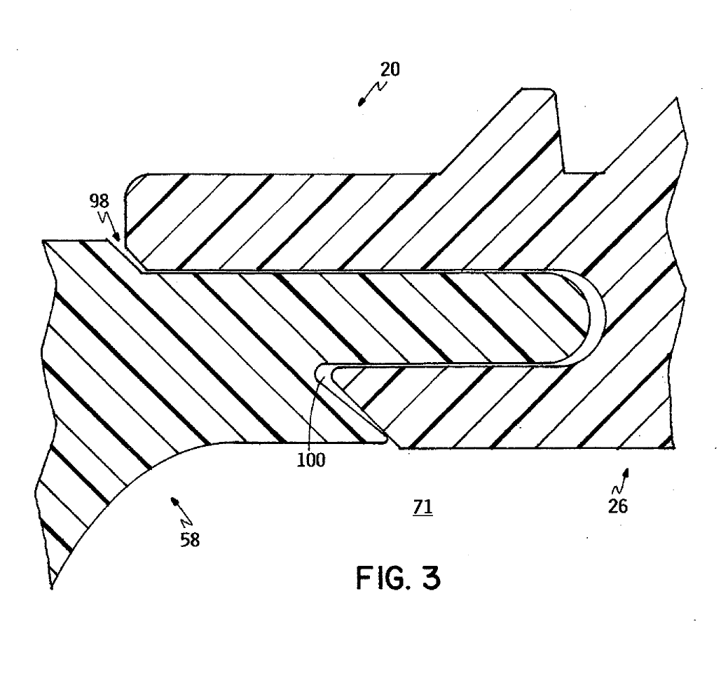

An O-ringless fluid tight seal is created by the coupling of containment portion 22, and body portion 24. In operation, containment portion 22, and body portion 24 are coupled through the use of nut 92. An operator advances nut 92 to the proximal end 68 of containment portion 22 so that shoulder 94 abuts shoulder 90. Both nut 92 and containment portion 22 are advanced so that the proximal end 68 of radiused surface 88 is inserted into the proximal end 48 of gap 36, as depicted in FIG. 3. An operator then turns nut 92 so that internal threads 96 engage with external threads 28, and continues turning nut 92 so that mating portion 26 engages with mating portion 58 such that the frustoconical surfaces initially confront one another then engage.

According to certain embodiments of the invention, as depicted in FIG. 3, proximal end 68 of first sealing surface 74 contacts distal end 50 of first sealing surface 42, however as a result of the unequal values of angle θ1 and angle θ3, a wedge-shaped gap 100 exists between convex frustoconical sealing surface 74 and concave frustoconical sealing surface 42. At this point, gap 98 is present between third sealing surface 76 and third sealing surface 56. A gap is also present between the surfaces of rim portion 70 and the surfaces of annular groove portion 36. The initial engagement is proximate the interior or fluid chamber 71 defined by the body portion and containment portion.

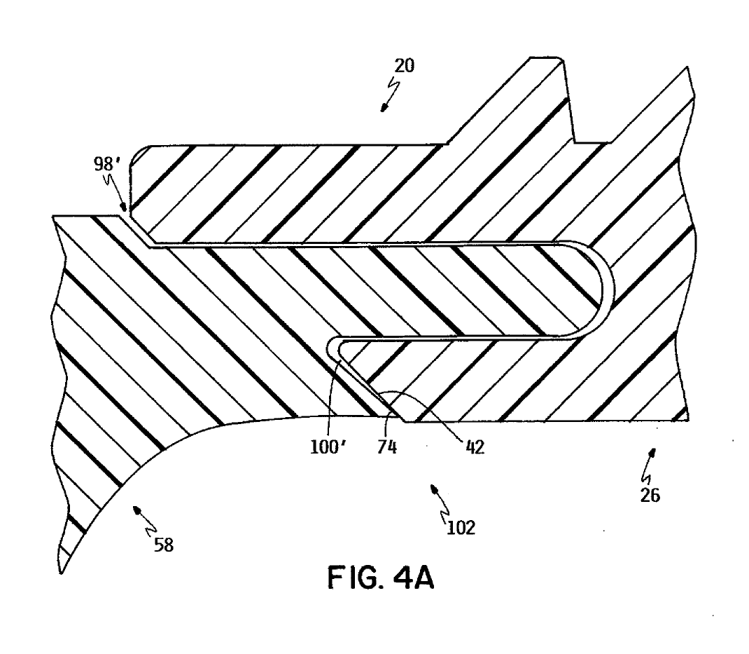

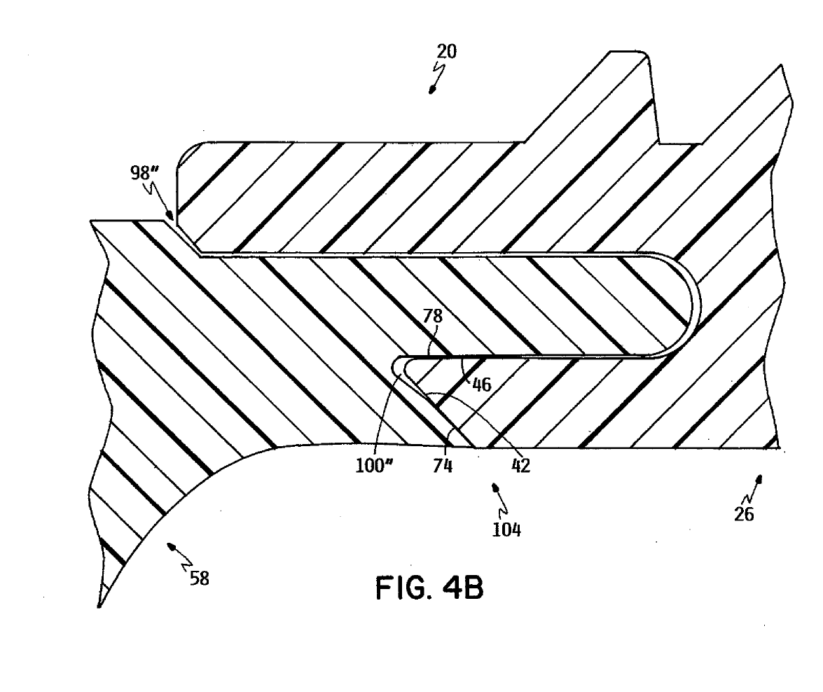

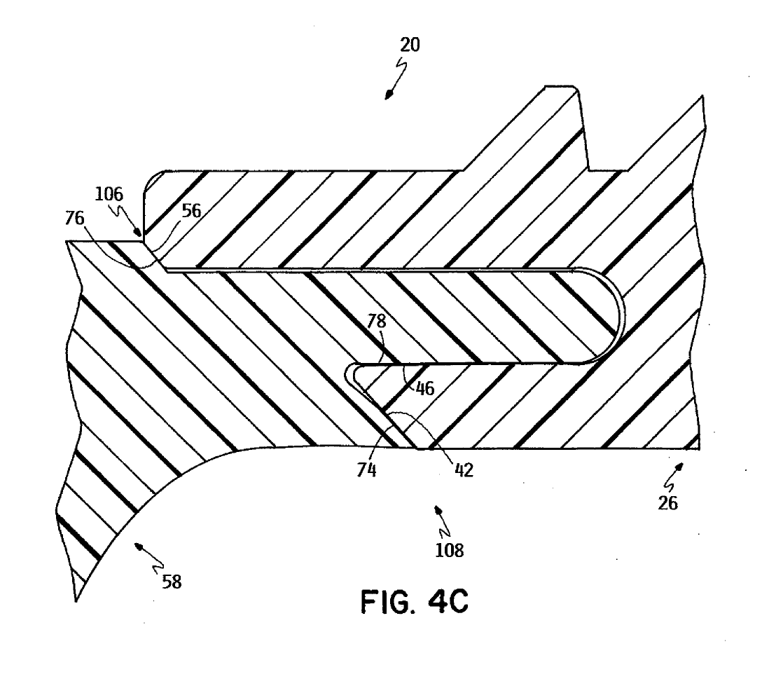

An O-ringless seal can be accomplished by additional turning of nut 92 so that an axially compressive force is exerted on frustoconical sealing surfaces 74, 42. Nut 92 is tightened until the cross-sectional areas of gaps 98, 100 have been reduced, as depicted by reference numbers 98′, 100′. At this point, either sealing surface 74 is deformed or deflected; sealing surface 42 is deformed or deflected; or both sealing surface 74 and sealing surface 42 are deformed or deflected, according to certain embodiments of the invention. An example embodiment where sealing surface 74 has been deformed, creating an O-ringless seal 102, is depicted in FIG. 4A.

According to certain embodiments of the invention, a further O-ringless seal can be accomplished by additional turning of nut 92 to increase the axially compressive force. Due to the interaction of the axially compressive force and the angled geometry of sealing surface 42 and sealing surface 74, second sealing surface 46 and second sealing surface 78 can be brought into contact. Additional turning of nut 92 further increases the axially compressive force, which can result in a deformation or deflection of at least one of second sealing surface 46; and second sealing surface 78. An example embodiment where second sealing surface 46 has been deformed, creating an O-ringless seal 104, is depicted in FIG. 4B. At this point, the cross-sectional areas of gaps 98′, 100′ have been further reduced, as depicted by reference numbers 98″, 100″.

According to certain embodiments of the invention, a further O-ringless seal can be accomplished by additional turning of nut 92 to increase the axially compressive force. Due to the axially compressive force, gap 98″ can be further reduced and proximal end 68 of third sealing surface 76 contacts distal end 50 of third sealing surface 56, however as a result of the unequal values of angle φ2 and angle φ4, a wedge-shaped gap 106 can still exist between third sealing surface 76 and third sealing surface 56. A further O-ringless seal can be accomplished by additional turning of nut 92 so that the cross-sectional area of gap 106 is reduced. At this point, either third sealing surface 76 is deformed or deflected; third sealing surface 56 is deformed or deflected; or both third sealing surface 76 and third sealing surface 56 are deformed or deflected. An example embodiment where third sealing surface 56 has been deformed, creating an O-ringless seal 108, is depicted in FIG. 4C. Due to the interaction of the axially compressive force; the angled geometry of sealing surface 42 and sealing surface 74; and the angled geometry of third sealing surface 56 and third sealing surface 76, the deformation or deflection of at least one of second sealing surface 46 and second sealing surface 78 is further encouraged.

According to certain embodiments of the invention, mating portions 26, 58 can be configured with hard stops, which prevent the advancement of mating portion 26 relative to mating portion 58 beyond a predetermined distance. In one embodiment, mating portions 26, 58 can be configured such that radiused surface 88 abuts radiused surface 86 to create a hard stop. In another embodiment, mating portions 26, 58 can be configured such that the distal end 66 of concave frustoconical sealing surface 74 abuts the proximal end 48 of concave frustoconical sealing surface 42 to create a hard stop.

When polymer body portion 24 engages polymer containment portion 22 and an O-ringless fluid sealing connection is formed, each of fluid flow conduits 120, 122 are operably connected to operative portion 60.

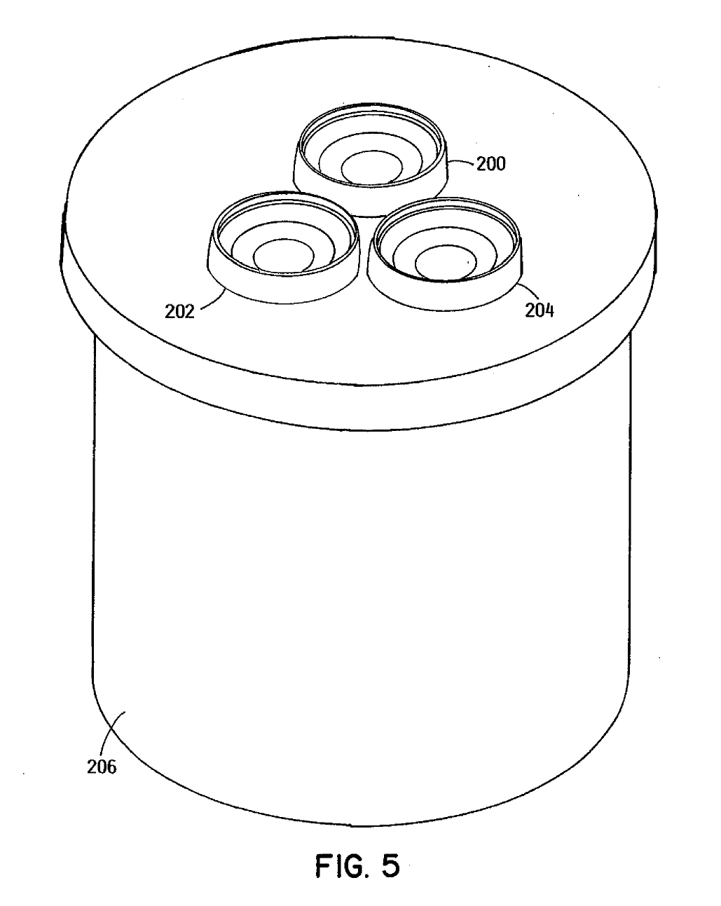

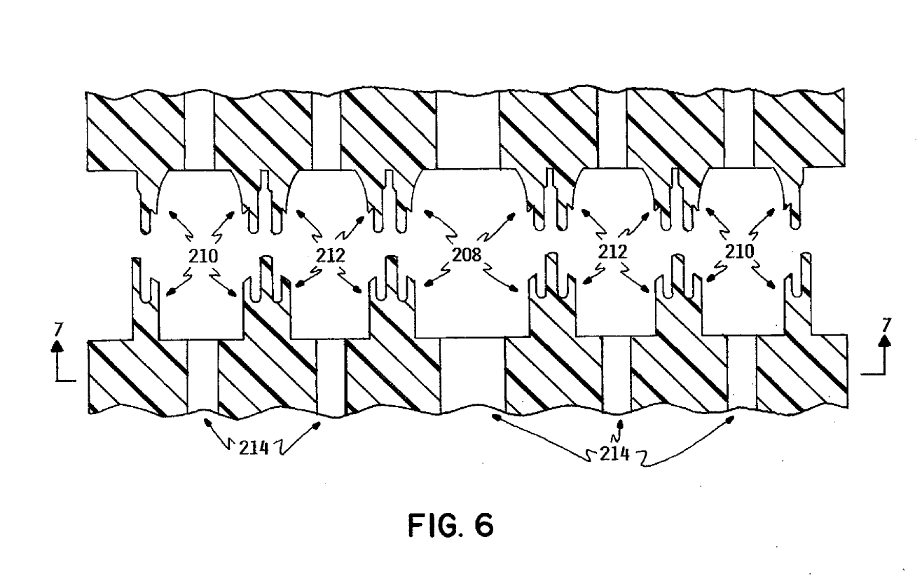

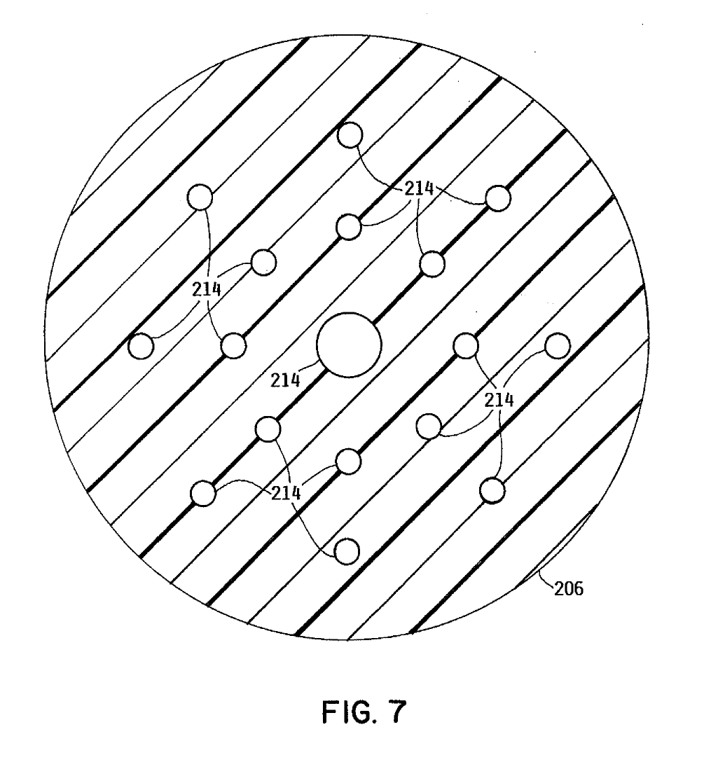

Another aspect of certain embodiments of the present invention can be the placement of multiple mating portions 200, 202 and 204 in close proximity, as depicted in FIG. 5. In other embodiments, the placement of multiple mating portions 208, 210, and 212 can be concentric. A concentric arrangement of mating portions 26 or 58 requires that the innermost coupling 208 be assembled from a single mating portion 26 and a single mating portion 58, as schematically depicted in FIG. 6. For each successive coupling arranged concentrically outward of a first coupling, for example couplings 210 and 212, a pair of mating portions 26 must be assembled with a pair of mating portions 58 in order to create a fluid path that only contacts the “wet” side of the O-ringless seal. The fluid paths 214 of such a concentric arrangement are depicted in FIGS. 6 and 7.

In applications such as for a photolithography filter, three O-ringless couplings can be required (one for each of inlet, outlet, and vent) in a single molded filter housing 206. Due to the effects of molded-part dimensional changes during the molding and curing processes, groupings depicted in FIGS. 5 & 6 can enable tighter tolerances as compared to a linear placement of the coupling mating portions.

Although specific examples have been illustrated and described herein, it will be appreciated by those of ordinary skill in the art that any arrangement calculated to achieve the same purpose could be substituted for the specific examples shown. This application is intended to cover adaptations or variations of the present subject matter. Therefore, it is intended that the invention be defined by the attached claims and their legal equivalents. For example the frustoconical surfaces could include surfaces having a slight contour and not being completely geometrically “conical”. In particular embodiments, the frustoconical surfaces may have different outside diameters whereby upon complete sealing engagement one of the frustoconical surfaces will be deformed and engaged from the inside diameter to the outside diameter and the other will be engaged at a more limited area.

1. An operative fluid device comprising a polymer body portion and a polymer containment portion engaging one another at a fluid sealing connection, the body portion comprising a pair of fluid flow conduits, and an operative portion contained at least partially in an interior for containing the fluid and defined by the body portion and containment portion and having a common axis, the operative portion providing one of fluid control, fluid conditioning, and fluid measurement, the body portion defining a first cylindrical interior wall portion with a first cylindrical wall surface portion at the fluid tight seal, the containment portion defining a second cylindrical interior wall portions and second cylindrical interior wall surface portion at the fluid tight seal, the first and second interior wall portions positioned to be in contact with the fluid, the fluid tight seal comprising:
a first mating portion integral with the body portion, a second mating portion integral with the containment portion, the first mating portion having a concave frustoconical sealing surface adjoining the first interior wall surface portion and being positioned on a tip of a first annular ring extending axially away from the body portion, the first mating portion further comprising a second annular ring extending axially away from the body portion, parallel to and spaced from the first angular ring by a gap, the second annular ring having a rounded tip and protruding farther axially away from the body portion than the tip of the first annular ring;
the second mating portion having a convex frustoconical sealing surface adjoining the second interior wall surface portions, a radial outward edge of said convex frustoconical sealing surface adjoining a third annular ring extending radially away from the containment portion, said third annular ring sized to fit within the gap of the first mating portion, said third annular ring having a tip and protruding farther away from the containment portion than the convex frustoconical sealing surface;
the containment portion compressively connectable to the body portion;
said frustoconical surfaces positioned to engage and seal without O-rings or gaskets when the containment portion is compressively connected to the body portion, each of said frustoconical surfaces having an acute angle taken from the common axis and said acute angles being before the frustoconical surfaces are engaged being different whereby an initial contact between the frustoconical surfaces as the containment portion is being compressively connected to the body portion is adjacent at least one of the interior wall surface portions.

2. The operative fluid device of claim 1 wherein each of the frustoconical surfaces has an inner diameter at engagement and concave frustoconical surface has an inner diameter equal to or within 3% of the inner diameter of the convex frustoconical surface.

3. The operative fluid device of claim 1 wherein the operative portion is one of a filter and a valve.

4. The operative fluid device of claim 1 wherein the body portion and the containment portion are comprised of at least one of perfluoroalkoxy and polytetrafluoroethylene.

5. The operative fluid device of claim 1 wherein one of the acute angles of the frustoconical surfaces taken from the common axis before engagement of the frustoconical surfaces is in the range of forty-three to forty-seven degrees and the other of the acute angles of the frustoconical surfaces taken from the common axis before engagement of the frustoconical surfaces is forty eight degrees to fifty-three degrees.

6. The operative fluid device of claim 5 wherein the body portion and the containment portion are comprised of at least one of perfluoroalkoxy and polytetrafluoroethylene.

7. An operative fluid device comprising a polymer body portion and a polymer containment portion connectable to one another, an interior defined by the body portion and containment portion when they are connected to one another for containing the fluid, an operative portion contained at least partially in said interior of the device, the operative portion configured for one of fluid control, fluid conditioning, and fluid measurement, each of the body portion and the containment portion engaging one another at a pair of mating portions when they are connected, the mating portions defining a fluid sealing connection without gaskets or O-rings, the fluid sealing connection comprising:
two frustoconical surfaces that first confront one another and then engage one another as the connection is made, one of the frustoconical surfaces being convex and the other concave, wherein when the surfaces are confronting one another before they are engaged they are angularly mismatched, and wherein the frustoconical surfaces first sealing contact is at a radially inward annular position on each of the frustoconical surfaces and proximate the interior, and as the mating portions are urged together, the sealing contact expands from the radially inward annular position radially outward to include majority of at least one of the two angularly mismatched frustoconical surfaces each of the mating portions having an axially extending annular ring positioned radially outward from the respective frustoconical surface and extending axially forward of the respective frustoconical surfaces.

8. The operative fluid device of claim 7 wherein each of the mating portions includes an annular axially extending recess that engages with an annular axially protruding portion on the other mating portion.

9. The operative fluid device of claim 8 wherein each of the mating portions is integral and formed with the fluoropolymer body portion and the fluoropolymer containment portion respectively.

10. An operative fluid device comprising a polymer body portion and a polymer containment portion engageable at a fluid sealing connection, the body portion and containment portion having an axis and defining an interior for containing the fluid, an operative portion contained at least partially in the interior, the operative portion configured for one of fluid control, fluid conditioning, and fluid measurement, the fluid sealing connection not utilizing an O-ring or gasket and comprising:
two frustoconical surfaces that confront one another as the connection is made, one of the frustoconical surfaces being convex and having an acute angle taken from the axis and the other frustoconical surface being concave and having an acute angle from the axis, the acute angle of the convex frustoconical surface being less that the acute angle of the frustoconical concave surface as the surfaces confront one another.

11. The fluid sealing connection of claim 10 wherein when the frustoconical surfaces initially engage during the first sealing contact, said engagement is at a radially inward annular position on each of the frustoconical surfaces and as the mating portions are urged together, the sealing contact expands from the radially inward annular initial engagement position as the frustoconical surfaces are axially loaded radially outward to include majority of the two angularly mismatched frustoconical surfaces.

12. A method of forming a fluid sealing connection, the method comprising the steps of:
confronting a concave frustoconical sealing surface on a first mating portion formed of a fluoropolymer with an axially aligned convex frustoconical sealing surface on a second mating portion formed of a fluoropolymer, each of the frustoconical sealing surfaces integral with a pair of connectable housing components of a operative fluid device, each of the frustoconical sealing surfaces surrounding a fluid containment region, the frustoconical sealing surfaces angularly mismatched;
compressively and axially loading the frustoconical sealing surfaces while constraining them radially to maintain the axial alignment with a pair of axially extending annular rings, one of the annular rings integral with the concave frustoconical sealing surface of the first mating portion and the other annular ring integral with the convex frustoconical sealing surface of the second mating portion each of the annular rings extending axially forward of the respective frustoconical surfaces;
wherein the frustoconical surfaces initially engage at a radially inward sealing engagement on each of said surfaces and by way of deformation of the frustoconical surfaces said engagement radially expands increasing the sealing engagement to include the majority of at least one of the frustoconical sealing surfaces.

13. The method of claim 12 further comprising the step of providing an additional pair of sealing surfaces integral with one of the pair of housing components, the pair of scaling surfaces radially spaced outwardly from two frustoconical surfaces.

14. The method of claim 13 further comprising the step of providing an additional pair of sealing surfaces radially spaced outwardly from additional pair of sealing surfaces of claim 13.

15. An operative fluid device comprising a pair of housing components engaged at a fluid sealing juncture, an operative portion contained at least partially in an interior defined by the pair of housing components for containing the fluid, the operative portion providing one of fluid control, fluid conditioning, and fluid measurement, each of the body portion and the containment portion defining a pair of cylindrical interior wall surface portions at the fluid sealing juncture, the pair of cylindrical interior wall surface portions positioned to be in contact with the fluid, the fluid sealing juncture comprising:
a pair of two mating portions each integral with one of the two housing components and each having one of two angularly mismatched frustoconical surfaces confronting one another as the connection is made, one of the frustoconical surfaces convex and the other concave, whereby the frustoconical surfaces first sealing contact is at a radially inward annular position on the frustoconical surfaces and as the mating portions are urged together, the sealing contact expands from the radially inward annular position radially outward to include majority of the two angularly mismatched frustoconical surfaces.

16. A method of forming a fluid sealing connection without O-rings or gaskets, the method comprising the steps of:
confronting a concave frustoconical sealing surface formed of a polymer with an axially aligned convex frustoconical sealing surface formed of a polymer, the frustoconical sealing surfaces angularly mismatched during the confrontation;
compressively and axially loading the frustoconical sealing surfaces while constraining them radially with annular rings projecting axially forward of each of the frustoconical surfaces to maintain the axial alignment wherein the frustoconical surfaces initially engage at a radially inward sealing engagement on each of said frustoconical sealing surfaces and by way of deformation of the frustoconical surfaces said engagement radially expands increasing the sealing engagement to include the majority of at least one of the frustoconical sealing surfaces as the frustoconical sealing surfaces are compressively and axially loaded.

17. The method of claim 16 further comprising the step of sealingly engaging an additional pair of annular sealing surfaces radially outboard from the pair of frustoconical sealing surfaces.

18. A polymer fluid sealing coupling without an O-ring or gasket, the coupling comprising:
a first polymer mating portion and a second polymer mating portion directly engageable to one another,
the first mating portion having a concave frustoconical sealing surface adjoining an interior wall surface portion defining a fluid conduit,
the second mating portion having a convex frustoconical sealing surface adjoining an interior wall surface portion also defining the fluid conduit,
the first mating portion having an axially extending annular ring;
the second mating portion having an axially extending annular ring,
whereby when the first mating portion is engaged with the second mating portion, the axially extending rings radially constrain the frustoconical sealing surfaces as the frustoconical surfaces confront and engage one another.

19. The fluid sealing coupling of claim 18 wherein the axially extending annular ring of the first mating portion extends axially forward of the concave frustoconical sealing surface and the axially extending annular ring of the second mating portion extends axially forward of the convex frustoconical sealing surface.

20. A photolithographic filter having three couplings, one for an inlet, one for a vent, and one for an outlet, each of the three couplings configured as in claim 19.
